(19) United States
(12) Patent Application Publication
(10) Pub. No.: US 2007/0105062 A1
(43) Pub. Date: May 10, 2007

(54) Expansion screw for correcting misalignment of teeth

(76) Inventor: Rolf Forster, Pforzheim (DE)

Correspondence Address: Orum & Roth LLC, Suite 1616, 53 W. Jackson Blvd., Chicago, IL, 60604, US

(21) Appl. No.: 11/594,594

(22) Filed: Nov. 7, 2006

(30) Foreign Application Priority Data
Nov. 8, 2005 (DE) 10 2005 053 891.6

(51) Int. Cl. A61C 3/00

(52) U.S. Cl. 433/7

(57) ABSTRACT

The invention describes an expansion screw made from at least one first metal or from at least one first alloy, for correcting misalignment of teeth, having two bodies that can be varied with respect to their spacing by means of a spindle, which latter comprises an actuator element and, projecting from the latter, one threaded portion or two threaded portions which extend in opposite directions one relative to the other, each of them being rotatably seated in one of the bodies and engaging an inner thread in the body, and having at least one slide guide that is in engagement with the two bodies and acts to guide them along a straight line, while preventing them from twisting one relative to the other as their spacing is being varied. It is provided according to the invention that at least the one threaded portion or, in the case of two threaded portions, at least one of such threaded portions of the spindle is coated with a second metal or with a second alloy that differs in hardness from the at least one first metal or from the at least one first alloy.

The present invention relates to an expansion screw having the features defined in the preamble of claim 1. An expansion screw of that kind has been known from DE 824 832. The known expansion screw comprises two bodies the spacing of which can be varied by means of a spindle. The spindle comprises an actuator element and, projecting from the latter, two threaded portions which extend in opposite directions one relative to the other and which are provided with a left-hand thread and a right-hand thread, respectively. Each of the threaded portions is rotatably seated in one of the bodies and engages an inner thread in the body. The inner threads are formed in two nuts, each of which is received in a recess in each of the two bodies, where it is permitted to slide, while being fixed against twisting. The nuts are subjected to the effect of a spiral spring that acts between the nut and the end of the respective expansion screw body. In order to prevent twisting of the two bodies of the expansion screw one relative to the other as the spindle rotates, two guide pins are provided in parallel to the spindle, which pins are fixed in matching bores in the one expansion screw body and are slidably guided in lengthwise direction in correspondingly aligned bores in the other expansion screw body.

EP 0 817 596 B1 discloses another expansion screw having the features defined in the preamble of claim 1, where the springs are made from a form-memory alloy that is pseudoelastic at the temperatures prevailing in a person's mouth.

There are further known expansion screws where the spindle is screwed directly into an inner thread of an expansion screw body so that a direct, non-cushioned connection exists between the spindle and the expansion screw bodies.

It is important for the progress of the treatment that can be achieved using an expansion screw in correcting misalignment of teeth that the spindle will remain in the position adjusted by the treating orthodontist and will not alter its adjustment by itself while located in a person's mouth. Consequently, a sufficient blocking effect must be obtained between the spindle and the nut thread. For reasons of corrosion-resistance, the expansion screw bodies formerly were made from German silver, while the guide pins and, in some cases, the nuts and the spindles were made from stainless steel. It was possible in this case to achieve sufficient blocking by selecting a sufficiently small pitch and tight tolerances between the spindle and the nut thread engaged by it. For reasons of biocompatibility, however, German silver in expansion screws meanwhile has been replaced by stainless steel. This had the effect to considerably reduce the blocking action between the spindle and its nut thread.

In the past, various attempts have been made in connection with orthodontic expansion screws, made from stainless steel throughout, to improve the blocking effect of the spindle in the nut thread. A known solution consists in squeezing the nut thread a little together. Although this actually improves the blocking effect, it is a disadvantage that the extent of the blocking effect can be reproduced only with difficulty so that considerable differences with respect to the blocking effect are encountered within a series of expansion screws.

It has further been known to inject a curable plastic material into the gap between the spindle and its nut thread. In this case, it is necessary that the play between the spindle and its nut thread must not be excessively small. But even then, the plastic material will penetrate into the nut thread over a fraction of its length only. This has the result that in spite of the injection of plastic material a certain play of the spindle will be left, which is undesirable in use of the expansion screw. However, injecting a plastic material into the gap between the spindle and its nut thread increases the production cost of the expansion screw quite considerably.

Another known possibility consists in providing a plastic sleeve between the spindle and the nut thread. It is a disadvantage of that solution that a larger gap is required between the threaded portions of the spindle and the nut thread and that the plastic sleeve must be manufactured and assembled separately. This considerably increases the production cost of the expansion screw and leads to gaps that cannot be cleaned and that may form a source of bacterial contamination.

Now, it is the object of the present invention to show in connection with expansion screws where the expansion screw body, the spindle, the nut thread and, if applicable, any springs present are made from steel, how the blocking effect between the spindle and the nut thread can be improved to a reproducible level at low cost.

This object is achieved by an expansion screw having the features defined in claim 1. Advantageous further developments of the invention are the subject-matter of the sub-claims.

According to the invention, the spindle of the expansion screw is coated at least on its threaded portion or, if two threaded portions are present, on at least one of the two threaded portions, with a second metal or a second alloy that differs in composition and/or in hardness from the at least one first metal or from the at least one first alloy. That solution offers considerable advantages:
The coating actually increases the blocking effect to a sufficient degree.
The thickness of the coating can be made easily reproducible if the conditions under which the coating is applied are kept constant.
The coating can be applied on a basic material of the spindle, especially on stainless steel, either directly or over a thin intermediate adhesive layer, and will adhere to that material with sufficient strength. Gold, which is preferred as a coating material, adheres to stainless steel directly and strongly.
Experience has shown that gold, being the preferred material, is corrosion-resistant and biocompatible under the conditions prevailing in a person's mouth.
The desired blocking effect is achieved already by a very thin coating. Good results have been achieved with a gold plating having a mean thickness as small as 0.3 μm to 0.5 μm. The lower limit for the thickness of the coating, especially a gold plating, preferably should be 0.1 μm. That thickness already provides a closed layer that improves the blocking effect. Preferably, the coating, especially the gold plating, has a mean thickness of maximally 1 μm. Greater layer thickness no longer have the effect to considerably improve the blocking effect, but may be suited to bridge greater tolerances between the threaded portion of the spindle and the nut thread. More conveniently, however, the tolerances between the threaded portions of the spindle and the nut thread should be kept small.
The coating can be applied at extraordinarily low cost, especially by a galvanic separation process. Still, it is also possible, though connected with somewhat higher cost, to apply the coating using a chemical separation process, without any use of external current, a PVD process or by sputtering.

An especially advantageous solution is achieved when the at least one first metal and/or the at least one first alloy, from which the spindle and the elements that contain the nut threads for the spindle are made, and the second metal and/or the second alloy with which at least one threaded portion of the spindle is coated, are clearly different in hardness. Related to the harder material, the difference in hardness should be at least 30%. Preferably, the difference in hardness is 50% or more.

A material especially well suited for coating the spindle is gold as the second metal and/or a gold alloy as the second metal alloy, especially one with a high gold content of at least 70% by weight, especially a gold alloy free from nickel and copper. Gold is advantageous because of its inert behavior, and has been found to perform well in a person's mouth. Other metals and alloys are, however, likewise imaginable provided they are stable under the conditions prevailing in a person's mouth: Stable to saliva, food and beverages, and stable to the generation of electrochemical potentials relative to other materials that may be installed in the person's mouth.

Preferably, the spindle is coated with pure gold. On the one hand, this can be realized at low cost, while on the other hand it also leads to the best possible results, as regards the improvement of the blocking effect. Although the use of a gold alloy with high gold content, especially a nickel-free and copper-free gold alloy having a gold content of at least 75% by weight, is like possible, pure gold is preferred.

No coating is required on the actuator element of the spindle. Still, the spindle preferably will be coated over its full outside as coating the whole spindle will be cheaper, even in the case of gold, than leaving certain parts of the spindle uncoated.

The attached drawing shows an oblique view of an expansion screw according to the invention, illustrating the screw in

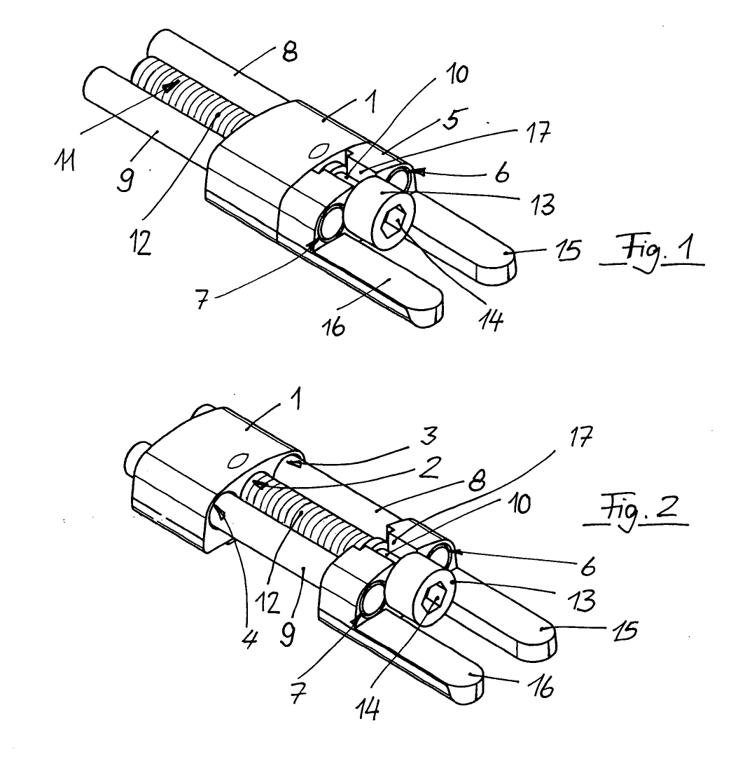

FIG. 1 in closed condition and in

FIG. 2 in expanded condition.

The expansion screw illustrated in the drawing comprises a first body 1 with a threaded bore 2 and two cylindrical bores 3 and 4, extending in parallel to the threaded bore 2. A second body 5 of the expansion screw comprises two cylindrical bores 6 and 7, aligned with the bores 3 and 4. Cylindrical guide pins 8 and 9 are fitted in non-sliding relationship, for example are pressed into, the cylindrical bores 6 and 7, while being slidably fitted in the bores 3 and 4 of the first body 1. The second body 5 comprises a recess 17 in which a threadless shaft 10 of a spindle 11 is retained in such a way that the spindle 11 is prevented from moving in its lengthwise direction in the second body 5. The spindle 11 comprises a threaded portion 12 which engages the threaded bore 2 of the first body 1 and which thereby performs the function of a nut thread for the spindle 11. The shaft 10 separates the actuator element 13 from the threaded portion 12 of the spindle 11 and has a diameter smaller than the diameter of the actuator element 13 and the threaded portion 12. The actuator element 13 has a cylindrical head in this case and comprises a hexagonal hole 14 in which a spanner can be fitted for turning the spindle 11.

The second body 5 of the expansion screw comprises two extensions 15 and 16 that serve as retention arms.

All parts of the expansion screw are made from a stainless steel, for example a number 14305 stainless steel. The spindle 11 is coated with gold all over, the gold having been applied, especially, by galvanic separation in a mean layer thickness of 0.3 μm to 0.4 μm. Due to the electrolytic metal separation process, the thickness of the gold layer is subject to variations as more metal will be deposited on peaks and edges due to the higher disconnection field strengths present in those areas, compared with plain or screened surface areas. With regard to those variations, the thickness of the coating therefore has been stated as “mean” values in the claims.

### LIST OF REFERENCE NUMERALS

1. first body
2. threaded bore
3. cylindrical bore
4. cylindrical bore
5. second body
6. cylindrical bore
7. cylindrical bore
8. cylindrical guide pins
9. cylindrical guide pins
10. threadless shaft
11. spindle
12. threaded portion
13. actuator element
14. hexagonal hole
15. extensions
16. extensions
17. recess

1. Expansion screw made from at least one first metal material, for correcting misalignment of teeth, having two bodies that are adjustable with respect to their spacing by a spindle, the spindle comprising an actuator element, one threaded portion projecting from the spindle each of them being rotatably seated in one of the bodies and engaging an inner thread in the body, at least one guiding means in engagement with the two bodies arranged and constructed to guide them along a straight line, while preventing the bodies from rotating one relative to the other as their spacing is being varied, least one threaded portion of the spindle is coated with a second metal material that differs in hardness from the at least one first metal material.

2. The expansion screw as defined in claim 1, wherein the at least one first metal material and the second metal material differ substantially in hardness.

3. The expansion screw as defined in claim 1, wherein the difference in hardness is at least 30% of the hardness of the harder material.

4. The expansion screw as defined in claim 1, wherein the difference in hardness is 50 % or more of the hardness of the harder material.

5. The expansion screw as defined in claim 1, wherein the second metal material is comprised of gold or a gold alloy.

6. The expansion screw as defined in claim 1, wherein the coating has a mean thickness of maximally 10 μm.

7. The expansion screw as defined in claim 6, wherein the coating has a thickness of maximally 1 μm.

8. The expansion screw as defined in claim 1, wherein the coating has a minimum thickness of 0.1 μm.

9. The expansion screw as defined in claim 1, wherein the coating has a mean thickness of 0.3 to 0.5 μm.

10. The expansion screw as defined in claim 1, wherein the spindle is coated with the second metal material over its full surface.

11. The expansion screw as defined in claim 1, wherein the spindle is coated with the second metal material by a chemical deposition process, without any use of external current.

12. The expansion screw as defined in claim 1, wherein the spindle is coated with the second metal material by a physical vapor deposition process.

13. The expansion screw as defined in claim 1, wherein the expansion screw bodies, the spindle, and any other fasteners that are engaged by the spindle are made from the same first metal material, the first metal material being a stainless steel.

14. The expansion screw as defined in claim 13, wherein the guiding means are made from the same first metal material.

15. The expansion screw as defined in claim 1, wherein the at least one first metal material is a first metal or a first alloy and in which the second metal material is a second metal or a second alloy.

16. Expansion screw made from at least one first metal material, for correcting misalignment of teeth, having two bodies that are adjustable with respect to their spacing by a spindle, the spindle comprising an actuator element, two threaded portions projecting from the spindle which extend in opposite directions one relative to the other, each of them being rotatably seated in one of the bodies and engaging an inner thread in the body, and having at least one guide in engagement with the two bodies arranged and constructed to guide them along a straight line, while preventing the bodies from rotating one relative to the other as their spacing is being varied, at least one of the two threaded portions of the spindle is coated with a second metal material that differs in hardness from the at least one first metal material.

17. The expansion screw as defined in claim 16, wherein the at least one first metal material and the second metal material differ substantially in hardness.

18. The expansion screw as defined in claim 16, wherein the difference in hardness is at least 30% of the hardness of the harder material.

19. The expansion screw as defined in claim 16, wherein the difference in hardness is 50% or more of the hardness of the harder material.

20. The expansion screw as defined in claim 16 wherein the second metal material is gold or a gold alloy.

21. The expansion screw as defined in claim 16, wherein the coating has a mean thickness of maximally 10 μm.

22. The expansion screw as defined in claim 21, wherein the coating has a thickness of maximally 1 μm.

23. The expansion screw as defined in claim 16, wherein the coating has a minimum thickness of 0.1 μm.

24. The expansion screw as defined in claim 16, wherein the coating has a mean thickness of 0.3 to 0.5 μm.

25. The expansion screw as defined in claim 16, wherein the spindle is coated with the second metal material over its full surface.

26. The expansion screw as defined in claim 16, characterized in that the spindle is coated with the second metal material by a chemical deposition process, without any use of external current.

27. The expansion screw as defined in claim 16, wherein the spindle is coated with the second metal material by a physical vapor deposition process.

28. The expansion screw as defined in claim 16, wherein the expansion screw bodies, the spindle, and any other fasteners that are engaged by the spindle are made from the same first metal material, the first metal material being a stainless steel.

29. The expansion screw as defined in claim 28, wherein the guiding means are likewise made from the same first metal material.

30. The expansion screw as defined in claim 16, wherein the at least one first metal material is a first metal or a first alloy and in which the second metal material is a second metal or a second alloy.

31. The expansion screw as defined in claim 1, wherein the expansion screw bodies, the spindle, and any other fasteners that are engaged by the spindle are made from the same first metal material, the first metal material being titanium.

32. The expansion screw as defined in claim 16, wherein the expansion screw bodies, the spindle, and any other fasteners that are engaged by the spindle are made from the same first metal material, the first metal material being titanium.
